(19) United States
(12) Patent Application Publication
(10) Pub. No.: US 2026/0349096 A1
(43) Pub. Date: Nov. 5, 2026

(54) MEASUREMENT APPARATUS

(71) Applicant: Panasonic Intellectual Property Management Co., Ltd., Osaka (JP)

(72) Inventors: KAZUKI NAKAMURA, Osaka (JP); KENJI NARUMI, Osaka (JP); HIROYUKI TAKAGI, Osaka (JP)

(21) Appl. No.: 19/704,445

(22) Filed: Jun. 11, 2026

Related U.S. Application Data
(63) Continuation of application No. PCT/JP2024/040704, filed on Nov. 15, 2024.

(30) Foreign Application Priority Data
Dec. 27, 2023 (JP) 2023-221609

(51) Int. Cl. G01S 7/4911; H01S 3/10

(52) U.S. Cl. CPC G01S 7/4911; H01S 3/10038

(57) ABSTRACT

A measurement apparatus includes a light-emitting element that emits light with which an object is irradiated and whose frequency changes periodically within a frequency range that is adjustable, a signal generation circuit that generates a digital periodic signal, an digital-to-analog conversion circuit that converts the digital periodic signal into an analog periodic signal and outputs the analog periodic signal, an amplitude-varying circuit that generates a driving signal by adjusting an amplitude of the analog periodic signal with a gain, a driving circuit that varies the frequency in accordance with the driving signal, and a signal line, electrically connected to the amplitude-varying circuit, through which the gain is controlled.

### BACKGROUND

### 1. Technical Field

The present disclosure relates to a measurement apparatus.

### 2. Description of the Related Art

There has been a LiDAR (light detection and ranging) technology for generating measurement data pertaining to the distance to and/or the velocity of an object by irradiating the object with light and detecting reflected light from the object. A typical example of a measurement apparatus involving the use of the LiDAR technology includes a light source, a photodetector, and a processing circuit. The light source emits light with which an object is irradiated. The photodetector detects reflected light from the object and thereby outputs a signal corresponding to a time delay in the reflected light. On the basis of the signal outputted from the photodetector, the processing circuit acquires data pertaining to the distance to and the velocity of the object, for example, through an FMCW (frequency modulated continuous wave) technology. Japanese Unexamined Patent Application Publication No. 2020-008475 discloses an example of a measurement apparatus involving the use of the FMCW technology.

### SUMMARY

One non-limiting and exemplary embodiment provides a measurement apparatus that is capable of more accurately acquiring measurement data pertaining to an object.

In one general aspect, the techniques disclosed here feature a measurement apparatus including a light-emitting element that emits light with which an object is irradiated and whose frequency changes periodically within a frequency range that is adjustable, a signal generation circuit that generates a digital periodic signal, a digital-to-analog conversion circuit that converts the digital periodic signal into an analog periodic signal and outputs the analog periodic signal, an amplitude-varying circuit that generates a driving signal by adjusting an amplitude of the analog periodic signal with a gain, a driving circuit that varies the frequency in accordance with the driving signal, and a signal line, electrically connected to the amplitude-varying circuit, through which the gain is controlled.

It should be noted that general or specific embodiments of the present disclosure may be implemented as a system, an apparatus, a method, an integrated circuit, a computer program, a computer-readable storage medium such as a storage disk, or any selective combination thereof. The computer-readable storage medium includes a nonvolatile storage medium such as a CD-ROM (compact disc read-only memory). The apparatus may be constituted by one or more apparatuses. In a case where the apparatus is constituted by two or more apparatuses, the two or more apparatuses may be placed in one piece of equipment or may be separately placed in two or more separate pieces of equipment. The term “apparatus” herein or in the claims can not only mean one apparatus but also mean a system composed of a plurality of apparatuses. The plurality of apparatuses included in the “system” can include an apparatus placed in a remote location away from another apparatus and connected via a communication network.

A technology of the present disclosure makes it possible to achieve a measurement apparatus that is capable of more accurately acquiring measurement data pertaining to an object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram schematically showing a configuration of a measurement apparatus according to an exemplary embodiment of the present disclosure;

FIG. 2A is a diagram schematically showing time changes in frequency of reference light and reflected light in a case where an object is at rest;

FIG. 2B is a diagram schematically showing time changes in frequency of the reference light and the reflected light in a case where the object is approaching the measurement apparatus;

FIG. 3 is a graph showing a relationship between distance from the measurement apparatus to the object and beat frequency;

FIG. 4 is a diagram schematically showing a relationship between the value of a current injected into a distributed-feedback laser diode and the frequency of a laser beam;

FIG. 5 is a diagram for explaining a correspondence relationship between a range of a current value and a frequency range in the graph shown in FIG. 4;

FIG. 6A is a diagram schematically showing relationships between the frequency of a laser beam and time in a narrow-range mode and a wide-range mode;

FIG. 6B is a diagram schematically showing relationships between the intensity of the laser beam and time in the narrow-range mode and the wide-range mode;

FIG. 7A is a flow chart showing an example of a measuring operation that a processing circuit executes;

FIG. 7B is a flow chart showing an example of a measuring operation that the processing circuit executes in step S101 shown in FIG. 7A;

FIG. 7C is a flow chart showing an example of a measuring operation that the processing circuit executes in step S104 shown in FIG. 7A;

FIG. 8 is a block diagram schematically showing a conventional configuration based on Japanese Unexamined Patent Application Publication No. 2020-008475 in which a laser beam is emitted;

FIG. 9 is a block diagram schematically showing a specific configuration of a light source and a processing circuit in a measurement apparatus according to the present embodiment;

FIG. 10 is a diagram schematically showing an example of an amplitude-varying circuit;

FIG. 11 is a graph schematically showing a relationship between the amplitude and S/N ratio of a driving signal in the present embodiment;

FIG. 12 is a flow chart showing an example of an operation that the processing circuit executes to drive the light source;

FIG. 13 is a graph showing a relationship between time and voltage of a driving signal in the light source in an example;

FIG. 14A is a graph showing, in closeup, a part of a relationship between driving voltage and time in a first example;

FIG. 14B is a graph showing, in closeup, a part of a relationship between driving voltage and time in a second example; and

FIG. 14C is a graph showing, in closeup, a part of a relationship between driving voltage and time in a third example.

### DETAILED DESCRIPTIONS

In the present disclosure, all or some of the circuits, units, apparatuses, members, or sections or all or some of the functional blocks in the block diagrams can be implemented as one or more electronic circuits including a semiconductor device, a semiconductor integrated circuit (IC), or an LSI (large scale integration). The LSI or IC can be integrated into one chip, or also can be a combination of multiple chips. For example, functional blocks other than a storage element may be integrated into one chip. The name used here is LSI or IC, but it may also be called system LSI, VLSI (very large scale integration), or ULSI (ultra large scale integration) depending on the degree of integration. A field programmable gate array (FPGA) that can be programmed after manufacturing an LSI or an RLD (reconfigurable logic device) that allows reconfiguration of the connection or setup of circuit cells inside the LSI can be used for the same purpose.

Further, it is also possible that all or some of the functions or operations of the circuits, units, apparatuses, members, or sections are implemented by executing software. In such a case, the software is stored on one or more non-transitory storage media such as a ROM, an optical disk, or a hard disk drive, and when the software is executed by a processor, the software causes the processor together with peripheral devices to execute the functions specified in the software. A system or an apparatus may include such one or more non-transitory storage media on which the software is stored and a processor together with necessary hardware devices such as an interface.

The term “light” herein means not only visible light (with wavelengths of approximately 400 nm to approximately 700 nm) but also electromagnetic waves including ultraviolet radiation (with wavelengths of approximately 10 nm to approximately 400 nm) and infrared radiation (with wavelengths of approximately 700 nm to approximately 1 mm). The ultraviolet radiation is herein sometimes referred to as “ultraviolet light”, and the infrared radiation is herein sometimes referred to as “infrared light”.

The following describes an exemplary embodiment of the present disclosure. It should be noted that the embodiments to be described below illustrate general or specific examples. The numerical values, shapes, constituent elements, placement and topology of constituent elements, steps, orders of steps, or other features that are shown in the following embodiments are merely examples and are not intended to limit the present disclosure. Further, those of the constituent elements in the following embodiments which are not recited in an independent claim representing the most generic concept are described as optional constituent elements. Further, the drawings are schematic views and are not necessarily strict illustrations. Furthermore, in the drawings, substantially identical components are given identical reference signs, and a repeated description may be omitted or simplified.

First, an underlying knowledge forming the basis of the present disclosure is explained.

In recent years, an FMCW-LiDAR technology has been under development that makes it possible to achieve both a wide dynamic range and high resolution for distance, makes it hard to be affected by disturbances, and makes it possible to acquire measurement data pertaining to the distance to and/or the velocity of an object moving at high speed. Utilizing light instead of millimeter waves makes it possible to make relatively small the diameter of a spot of light with which an object is irradiated, making it possible to bring about improvement in spatial resolution.

A measurement apparatus involving the use of the FMCW-LiDAR technology acquires measurement data pertaining to an object through the use of light whose frequency changes periodically. Japanese Unexamined Patent Application Publication No. 2020-008475 discloses a laser length measuring machine as an example of such a measurement apparatus. The laser length measuring machine includes a driving waveform signal generator, a digital-to-analog (DA) converter, a low-pass filter, a laser driver, and a laser element in this order. The driving waveform signal generator generates a triangular-wave digital signal. The DA converter converts the digital signal into an analog signal. The analog signal is a voltage signal. The low-pass filter generates a driving signal by removing a high-frequency component from the analog signal. The laser driver converts the driving signal into a current signal and supplies the current signal to the laser element. The laser element emits a laser beam whose frequency changes periodically in the form of a triangular wave.

As a result of the inventors having studied the aforementioned laser length measuring machine, it was found that in a case where the amplitude of an analog signal generated by the DA converter is small, there is deterioration in the repeatability with which measurement data pertaining to an object is repeatedly acquired under identical conditions. A reason for this is that in a case where the amplitude of an analog signal is small, a fluctuation in voltage attributed to noise caused by DA conversion becomes relatively larger with respect to the amplitude.

The inventors found this problem and conceived of a measurement apparatus according to an embodiment of the present disclosure that addresses the problem. The following describes a measurement apparatus according to the present embodiment.

### EMBODIMENTS

The following first describes a configuration of the measurement apparatus according to the present embodiment, the FMCW-LiDAR technology, a change in frequency according to distance measured, and a measuring operation. The following then describes problems with a conventional configuration in which a laser beam whose frequency changes periodically is emitted, a specific configuration of a light source and a processing circuit included in the measurement apparatus according to the present embodiment, a relationship between the amplitude and S/N ratio of a driving signal, an operation of driving the light source, and examples.

### Configuration of Measurement Apparatus

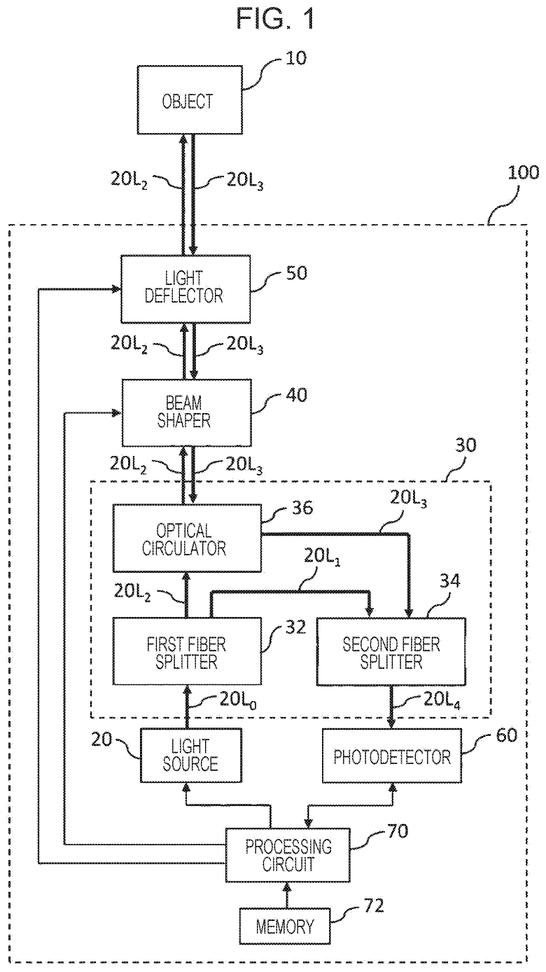

First, an example configuration of a measurement apparatus 100 according to an embodiment of the present disclosure is described with reference to FIG. 1. FIG. 1 is a block diagram schematically showing a configuration of a measurement apparatus according to an exemplary embodiment of the present disclosure. FIG. 1 shows an object 10 to be measured. The measurement apparatus 100 shown in FIG. 1 acquires measurement data pertaining to the distance to and/or the velocity of the object 10 through the use of a laser beam whose frequency changes periodically. The frequency varies within a frequency range that is adjustable.

As shown in FIG. 1, the measurement apparatus 100 includes a light source 20, an interference optical system 30, a beam shaper 40, a light deflector 50, a photodetector 60, a processing circuit 70, and a memory 72. The thick arrows shown in FIG. 1 represent the flow of light. The thin arrows shown in FIG. 1 represent the sending and receiving of signals.

The following describes the constituent elements of the measurement apparatus 100.

The light source 20 emits a laser beam 20L₀ whose frequency can be changed. The frequency can be changed over time with constant periodicity, for example, in the form of a triangular wave or a sawtooth wave. The periodicity of changes in frequency may vary. The periodicity of the frequency can be, for example, longer than or equal to 1 sec and shorter than or equal to 10 msec. A frequency width of the frequency is, for example, greater than or equal to 100 MHz and less than or equal to 1 THz. The wavelength of the laser beam can be included in a wavelength range of near-infrared light, for example, of 700 nm to 2000 nm. Since the amount of near-infrared light is smaller than the amount of visible light in sunlight, using near-infrared light as the laser beam 20L₀ makes it possible to reduce the influence of sunlight as noise. Alternatively, the wavelength of the laser beam 20L₀ may be included in a wavelength range of visible light of 400 nm to 700 nm or may be included in a wavelength range of ultraviolet light. The light source 20 can include, for example, a light-emitting element such as a distributed-feedback laser diode or a laser diode with an external resonator. These laser diodes are low in price and small in size, are capable of single-mode oscillation, and can vary the frequency of the laser beam according to the amount of current that is applied. A configuration of the light source 20 will be described in detail later.

The interference optical system 30 includes a first fiber splitter 32, a second fiber splitter 34, and an optical circulator 36. The first fiber splitter 32 separates the laser beam 20L₀ emitted from the light source 20 into reference light 20L₁ and irradiating light 20L₂. The first fiber splitter 32 inputs the reference light 20L₁ to the second fiber splitter 34 and inputs the irradiating light 20L₂ to the optical circulator 36. The optical circulator 36 inputs the irradiating light 20L₂ to the beam shaper 40. The optical circulator 36 inputs, to the second fiber splitter 34, reflected light 20L₃ produced by irradiating an object 10 with the irradiating light 20L₂. The second fiber splitter 34 inputs, to the photodetector 60, interfering light 20L₄ produced by causing the reference light 20L₁ and the reflected light 20L₃ to overlap and interfere with each other.

The beam shaper 40 adjusts the spot shape of the irradiating light 20L₂ emitted from the interference optical system 30. After beam shaping, the irradiating light 20L₂ can be, for example, flash light, a line beam, or a point beam. The beam shaper 40 can include, for example, a collimating lens.

The light deflector 50 changes the direction of the irradiating light 20L₂ emitted from the beam shaper 40. The light deflector 50 allows a target scene including the object 10 to be scanned by the irradiating light 20L₂. The light deflector 50 can include, for example, a MEMS (microelectromechanical system) mirror or a galvanometer mirror. Alternatively, the light deflector 50 may be a beam scan device, such as the one described in International Publication No. 2019/130720, that involves the use of an optical phased array and a slow light waveguide.

The photodetector 60 detects the interfering light 20L₄. The photodetector 60 includes one or more photodetection elements. The photodetection elements output signals corresponding to the intensity of the interfering light 20L₄ based on the laser beam 20L₀.

In the measurement apparatus 100, an optical path of the irradiating light 20L₂ from the interference optical system 30 to the object 10 and an optical path of the reflected light 20L₃ from the object 10 to the interference optical system 30 overlap each other. Employing such a coaxial optical system makes it possible to simplify the configuration of the measurement apparatus 100, making it possible to achieve a stable measurement. Alternatively, the measurement apparatus 100 may be designed so that the aforementioned two optical paths do not overlap each other.

The processing circuit 70 controls how the light source 20, the beam shaper 40, the light deflector 50, and the photodetector 60 operate. The processing circuit 70 processes, through the use of the FMCW-LiDAR technology, a signal outputted from the photodetector 60. On the basis of the signal, the processing circuit 70 generates measurement data pertaining to the distance to and/or the velocity of the object 10 and outputs the measurement data. The operation of the processing circuit 70 will be described in detail later.

A computer program that is executed by the processing circuit 70 is stored in the memory 72 such as a ROM or a RAM (random-access memory). Thus, the measurement apparatus 100 includes a processor including the processing circuit 70 and the memory 72. The processing circuit 70 and the memory 72 may be integrated on one circuit board, or may be provided on separate circuit boards. Functions of control and signal processing by the processing circuit 70 may be dispersed across a plurality of circuits. The processor may be placed in a place away from other constituent elements to control, via a cable or wireless communication network, how the light source 20, the beam shaper 40, the light deflector 50, and the photodetector 60 operate.

### FMCW-LiDAR Technology

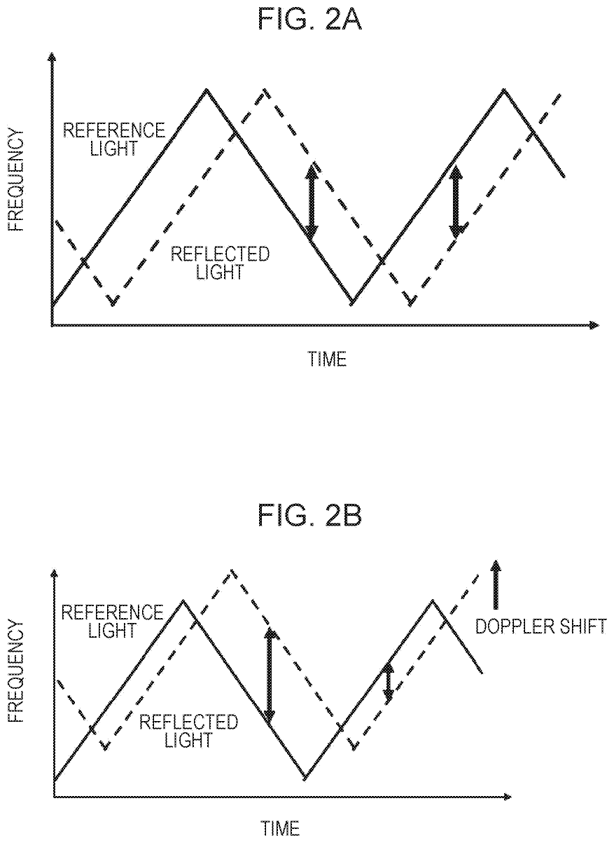

Next, the FMCW-LiDAR technology is briefly described with reference to FIGS. 2A and 2B. The FMCW-LiDAR technology is disclosed in detail, for example, in Christopher V. Poulton, et al., “Frequency-modulated Continuous-wave LIDAR Module in Silicon Photonics”, OFC2016, W4E.3, (2016).

FIG. 2A is a diagram schematically showing time changes in frequency of the reference light 20L₁ and the reflected light 20L₃ in a case where the object 10 is at rest. The solid line represents the reference light, and the dashed line represents the reflected light. The frequency of the reference light 20L₁ shown in FIG. 2A repeats time changes in the form of a triangular wave. That is, the frequency of the reference light 20L₁ repeats an up chirp and a down chirp. An increase in the frequency in an up chirp and a decrease in the frequency in a down chirp are equal to each other. The frequency of the reflected light 20L₃ shifts along a time axis as compared with the frequency of the reference light 20L₁. The amount by which the reflected light 20L₃ shifts in time is equal to the period of time from the emission of the irradiating light 20L₂ from the measurement apparatus 100 to the return of the irradiating light 20L₂ reflected off the object 10 as the reflected light 20L₃. As a result of that, the interfering light 20L₄ produced by causing the reference light 20L₁ and the reflected light 20L₃ to overlap and interfere with each other has a frequency corresponding to the difference between the frequency of the reflected light 20L₃ and the frequency of the reference light 20L₁. The double-headed arrows shown in FIG. 2A represent the difference in frequency between the reference light 20L₁ and the reflected light 20L₃. The photodetector 60 outputs a signal indicating the intensity of the interfering light 20L₄. The signal is called a beat signal. The frequency of the beat signal, i.e. a beat frequency, is equal to the aforementioned difference in frequency. The processing circuit 70 can generate, from the beat frequency, data pertaining to the distance to the object 10.

FIG. 2B is a diagram schematically showing time changes in frequency of the reference light 20L₁ and the reflected light 20L₃ in a case where the object 10 is approaching the measurement apparatus 100. In a case where the object 10 is approaching, a Doppler shift causes the frequency of the reflected light 20L₃ to shift in a direction of increase along a frequency axis as compared with a case where the object 10 is at rest. The amount by which the frequency of the reflected light 20L₃ shifts depends on a component obtained by projecting the velocity vector of the object 10 in the direction of the reflected light 20L₃. The beat frequency can vary between up-chirp and down-chirp periods of the reference light 20L₁ and the reflected light 20L₃. In the example shown in FIG. 2B, the beat frequency in the down-chirp periods of the reference light 20L₁ and the reflected light 20L₃ is higher than the beat frequency in the up-chirp periods of the reference light 20L₁ and the reflected light 20L₃. The processing circuit 70 can generate data pertaining to the velocity of the object 10 from the difference in beat frequency due to the Doppler shift. Furthermore, the processing circuit 70 can generate, from the average of beat frequencies in the up-chirp periods and the down-chirp periods, data pertaining to the distance to the object 10.

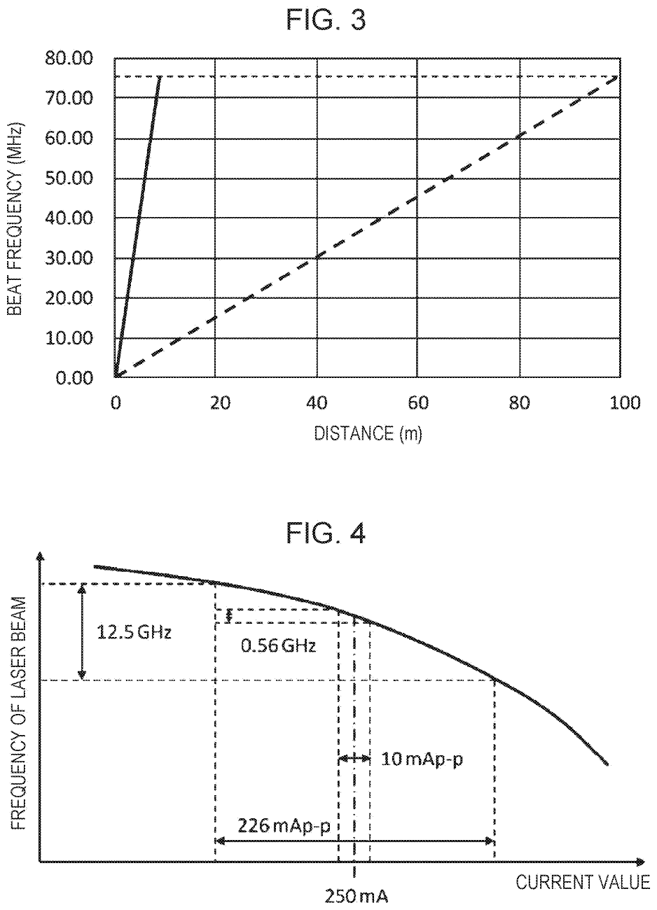

Next, a relationship between the distance from the measurement apparatus 100 to the object 10 and the beat frequency is described with reference to FIG. 3. Assuming that Δf is the frequency range in the up-chirp periods or the down-chirp periods, Δt is the time required to change by Δf, c is the speed of light, and d is the distance from the measurement apparatus 100 to the object 10, the beat frequency f_{beat} is represented by Formula (1) as follows:

$${f}_{beat} = \frac{2 Δ f}{c Δ t} d \qquad ( 1 )$$

The beat frequency f_{beat} in Formula (1) is obtained by multiplying the time rate of change Δf/Δt in the frequency by the time (2d/c) required to travel back and forth between the measurement apparatus 100 and the object 10.

FIG. 3 is a graph showing a relationship between the distance d from the measurement apparatus 100 to the object 10 and the beat frequency f_{beat} according to Formula (1). The thick solid line represents a mode in which Δf=12.5 GHz and Δt=10 μsec, i.e. in which the time rate of change in the frequency is given as Δf/Δt=1.25×10¹⁵ Hz/sec. The thick dashed line represents a mode in which Δf=1.12 GHz and Δt=10 μsec, i.e. in which the time rate of change in the frequency is given as Δf/Δt=1.12×10¹⁴ Hz/sec. The thin horizontal dashed line represents an example of a measurable maximum value of the beat frequency f_{beat}. In this example, the measurable maximum value is 75 MHz.

According to Formula (1), the range of distance measurement d increases as the time rate of change Δf/Δt in the frequency becomes lower. In the example shown in FIG. 3, with the measurable maximum value of the beat frequency f_{beat} taken into account, the range of distance measurement d is 9 m in a mode in which the time rate of change in the frequency is high and 100 m in a mode in which the time rate of change in the frequency is low. The mode in which the time rate of change in the frequency is high is a mode in which the range of distance measurement is narrow, i.e. a narrow-range mode. The mode in which the time rate of change in the frequency is low is a mode in which the range of distance measurement is wide, i.e. a wide-range mode.

The accuracy of distance measurement improves as the time rate of change in the frequency becomes higher. A reason for this is that as the time rate of change Δf/Δt in the frequency becomes higher, the amount of change in the beat frequency f_{beat} with respect to the amount of change in the distance d increases. The beat frequency f_{beat} is obtained by computing the Fourier transform of the beat signal as a function of time. The accuracy of distance measurement improves as the amount of change in the beat frequency f_{beat} becomes greater as compared with the frequency resolution of the Fourier transform. In the example shown in FIG. 3, making a distance measurement with a frequency resolution of 800 Hz in the narrow-range mode resulted in an accuracy of distance measurement of approximately 0.1 mm, and making a distance measurement with a frequency resolution of 800 Hz in the wide-range mode resulted in an accuracy of distance measurement of approximately several millimeters. This distance-measurement accuracy is repeatability based on 50 measurements.

In a case where the velocity is measured in addition to the distance, it is necessary that the beat frequency f_{beat} be equal to or less than the measurable maximum value when the amount of change due to the Doppler shift is added to the beat frequency f_{beat}. With the amount of change due to the Doppler shift taken into account, in the wide-range mode, in a case where Δf=0.56 GHz and Δt=10 μsec, i.e. where the time rate of change in the frequency is given as Δf/Δt=5.6×10¹³ Hz/sec, the accuracy of distance measurement was approximately several centimeters.

The narrow-range mode can be applied, for example, to a case where measurement data pertaining to an object 10 a short distance away is generated with a high degree of accuracy. The short distance can be, for example, longer than or equal to 0 m and shorter than or equal to 10 m. The wide-range mode can be applied, for example, to a case where measurement data pertaining to an object 10 a short distance away or a long distance away is generated with a certain degree of accuracy. The long distance can be, for example, longer than 10 m and shorter than or equal to 200 m. The time rate of change in the frequency in the narrow-range mode is determined by the measurable maximum value of the beat frequency f_{beat} in Formula (1) and the short distance d, and the time rate of change in the frequency in the wide-range mode is determined by the measurable maximum value of the beat frequency f_{beat} in Formula (1) and the long distance d.

### Change in Frequency According to Distance Measured

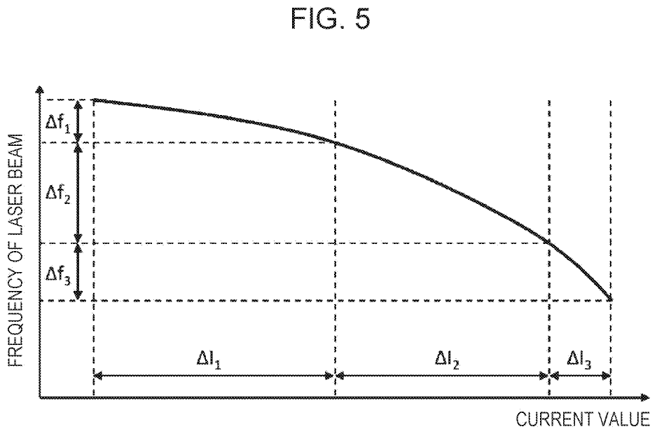

Next, a relationship between the value of a current applied to the distributed-feedback laser diode, which is as an example of the light-emitting element included in the light source 20, and the frequency of a laser beam is described with reference to FIG. 4. FIG. 4 is a diagram schematically showing a relationship between the value of the current applied to the distributed-feedback laser diode and the frequency of the laser beam 20L₀. Applying a current to the distributed-feedback laser diode causes an active layer included in the laser diode to be heated, so that there is a slight change in resonator length of the active layer. Along with the change in the resonator length, there is a change in the frequency of the laser beam 20L₀. As the value of the current applied becomes greater, the amount of change in the frequency of the laser beam 20L₀ increases along with an increase in the amount by which the active layer is heated.

In the example shown in FIG. 4, assuming that the current value is composed of a direct-current component of 250 mA and an alternate-current component of 266 mAp-p, the frequency range of the laser beam 20L₀ is given as Δf=12.5 GHz. Assuming that the current value is composed of a direct-current component of 250 mA and an alternate-current component of 10 mAp-p, the frequency range of the laser beam 20L₀ is given as Δf=0.56 GHz. In a case where the periodicity of the current applied is given as 2Δt=20 μsec, the time rate of change in the frequency given as Δf/Δt=1.25×10¹⁵ Hz/sec in the narrow-range mode and the time rate of change in the frequency given as Δf/Δt=5.6×10¹³ Hz/sec in the wide-range mode can be achieved.

In the example shown in FIG. 4, a portion in which the frequency of the laser beam nonlinearly varies with respect to the current value is used for the narrow-range mode and the wide-range mode. Furthermore, the direct-current component of the current value in the narrow-range mode and the direct-current component of the current value in the wide-range mode are the same. As a result of that, the frequency range in the narrow-range mode encompasses the frequency range in the wide-range mode.

Two different portions in which the frequency of the laser beam nonlinearly varies with respect to the current value may be used for the narrow-range mode and the wide-range mode. Next, a correspondence relationship between a range of the current value and the frequency range in the graph shown in FIG. 4 is described with reference to FIG. 5. FIG. 5 is a diagram for explaining a correspondence relationship between the range of the current value and the frequency range in the graph shown in FIG. 4. As shown in FIG. 5, in the range of the current value, ΔI₁, ΔI₂, and ΔI₃ are successively arranged in this order in a direction in which the current value increases. In the frequency range, Δf₁, Δf₂, and Δf₃ are successively arranged in this order in a direction in which the frequency decreases. Δf₁, Δf₂, and Δf₃ are ranges of frequencies that are obtained when the current value varies within ranges of ΔI₁, ΔI₂, and ΔI₃, respectively. The graph shown in FIG. 5 can be divided into a first correspondence relationship between ΔI₁ and Δf₁, a second correspondence relationship between ΔI₂ and Δf₂, and a third correspondence relationship between ΔI₃ and Δf₃. Each correspondence relationship is substantially linear. For the width of the range of the current value, the relationship ΔI₁>ΔI₂>ΔI₃ is satisfied, and for the width of the frequency range, the relationship Δf₂>Δf₃>Δf₁ is satisfied. For the ratio of the frequency range to the range of the current value, the relationship Δf₃/ΔI₃>Δf₂/ΔI₂>Δf₁/ΔI₁ is satisfied.

In the first correspondence relationship, the range of the current value in which linearity is attained is widest among the three correspondence relationships, and the frequency range is narrowest among the three correspondence relationships. In the second correspondence relationship, the range of the current value in which linearity is attained is narrower than in the first correspondence relationship, and the frequency range is widest among the three correspondence relationships. In the third correspondence relationship, the range of the current value in which linearity is attained is narrowest among the three correspondence relationships, and the frequency range is wider than in the first correspondence relationship.

In a case where the current applied is changed over time in the form of a triangular wave with the same periodicity 2Δt, the second correspondence relationship of the first to third correspondence relationships can be applied to the narrow-range mode, and the first and third correspondence relationships of the first to third correspondence relationships can be applied to the wide-range mode. A reason for this is that the time rate of change in the frequency in the second correspondence relationship is higher than the rates of change in the frequency in the first and third correspondence relationships. In the wide-range mode, more effective reflected light 20L₃ can be obtained from an object 10 a long distance away when the intensity of the irradiating light 20L₂ is higher. The intensity of the laser beam 20L₀ that is emitted from the light source 20 increases with the value of the current applied. In terms of obtaining the irradiating light 20L₂ with higher intensity, the third correspondence relationship is more suitable to the wide-range mode than the first correspondence relationship.

Note, however, that from an eye-safe point of view, the intensity of the irradiating light 20L₂ is lower than or equal to a predetermined intensity regardless of the wide-range mode or the narrow-range mode. This is because it is assumed that a person may suddenly enter a short-distance region, or that a person may observe from a long distance through binoculars. In a case where the wavelength is 1550 nm and the periodicity 2Δt of the triangular wave is so long as to be longer than or equal to 10 μsec in continuous emission, the intensity of irradiating light 20L₂ can be, for example, lower than or equal to 10 mW. A low-reflectivity object 10 may be present even a short distance away. Accordingly, regardless of the wide-range mode or the narrow-range mode, it is advantageous for the intensity of irradiating light 20L₂ to be as high as possible within 10 mW.

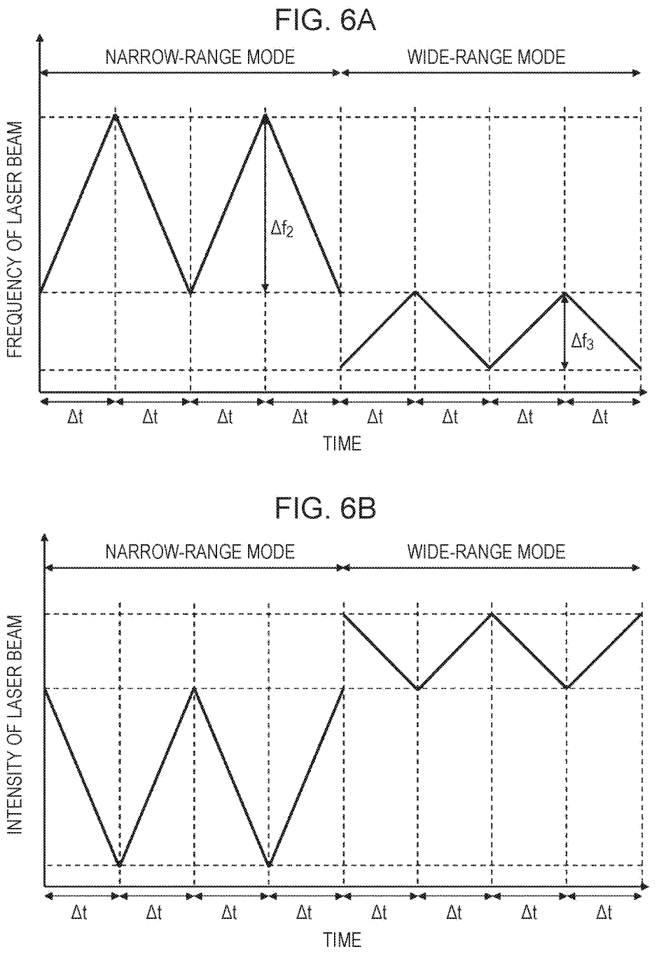

Next, examples of how the frequency and intensity of the laser beam 20L₀ change over time in the narrow-range mode and the wide-range mode are described with reference to FIGS. 6A and 6B. FIG. 6A is a diagram schematically showing relationships between the frequency of the laser beam 20L₀ and time in the narrow-range mode and the wide-range mode. FIG. 6B is a diagram schematically showing relationships between the intensity of the laser beam 20L₀ and time in the narrow-range mode and the wide-range mode. The narrow-range mode shown in FIGS. 6A and 6B is based on the second correspondence relationship shown in FIG. 5. The wide-range mode shown in FIGS. 6A and 6B is based on the third correspondence relationship shown in FIG. 5.

As shown in FIG. 6A, the frequency of the laser beam 20L₀ in the narrow-range mode periodically changes over time within a frequency range Δf₂, and the frequency of the laser beam 20L₀ in the wide-range mode periodically changes over time within a frequency range Δf₃. The periodicity 2Δt of changes in the frequency of the laser beam 20L₀ in the narrow-range mode and the periodicity 2Δt of changes in the frequency of the laser beam 20L₀ in the wide-range mode are equal to each other. By fixing the period regardless of the narrow-range mode or the wide-range mode, the change in the amount of heating of the active layer caused by increases and decreases in the applied current can be kept constant, thereby maintaining linear increases and decreases in the frequency.

Each period of change in frequency in the narrow-range mode includes a first up-chirp period and a first down-chirp period as follows. In the first up-chirp period, the frequency monotonically increases from a lower limit to an upper limit of the frequency range Δf₂, and in the first down-chirp period, the frequency monotonically decreases from the upper limit to the lower limit of the frequency range Δf₂. Each period of change in frequency in the wide-range mode includes a second up-chirp period and a second down-chirp period as follows. In the second up-chirp period, the frequency monotonically increases from a lower limit to an upper limit of the frequency range Δf₃, and in the second down-chirp period, the frequency monotonically decreases from the upper limit to the lower limit of the frequency range Δf₃.

A signal that is outputted from the photodetector 60 in the narrow-range mode contains a first signal component in the first up-chirp period and a second signal component in the first down-chirp period. The processing circuit 70 generates measurement data on the basis of the first and second signal components and outputs the measurement data. A signal that is outputted from the photodetector 60 in the wide-range mode contains a third signal component in the second up-chirp period and a fourth signal component in the second down-chirp period. The processing circuit 70 generates measurement data on the basis of the third and fourth signal components and outputs the measurement data. The measurement data in the narrow-range mode and the wide-range mode thus generated contains not only data pertaining to the distance to the object 10 but also data pertaining to the velocity of the object 10.

As shown in FIG. 6B, the intensity in the wide-range mode is higher than or equal to the intensity in the narrow-range mode. Accordingly, effective reflected light 20L₃ can be obtained from an object 10 a long distance away in the wide-range mode. If the intensity in the narrow-range mode is sufficiently high, effective reflected light 20L₃ can also be obtained from a low-reflectivity object 10 a short distance away. The intensity in the narrow-range mode can be, for example, higher than or equal to 1 mW and lower than or equal to 6 mW. The intensity in the wide-range mode can be, for example, higher than or equal to 6 mW and lower than or equal to 10 mW.

As shown in FIGS. 6A and 6B, the intensity decreases when the frequency increases, and the intensity increases when the frequency decreases. This relationship of increase and decrease is attributed to the fact that as shown in FIG. 5, the rate of change of the frequency with respect to the current value is negative.

### Measuring Operation

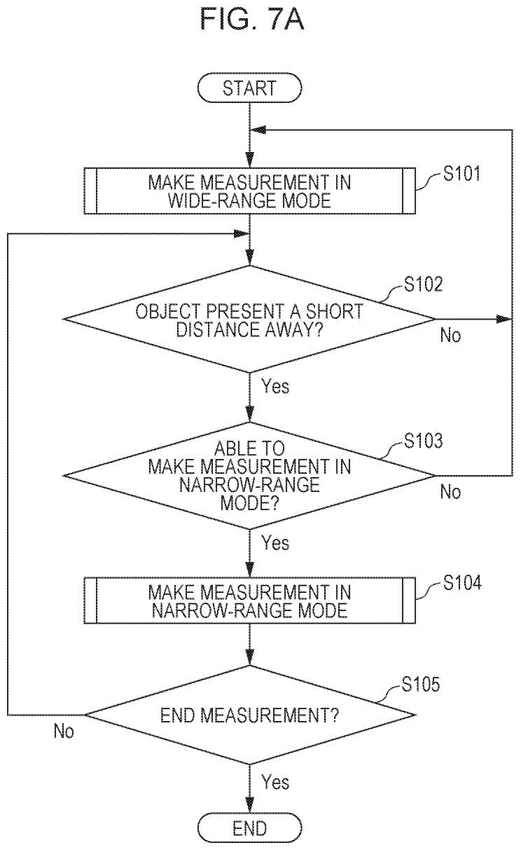

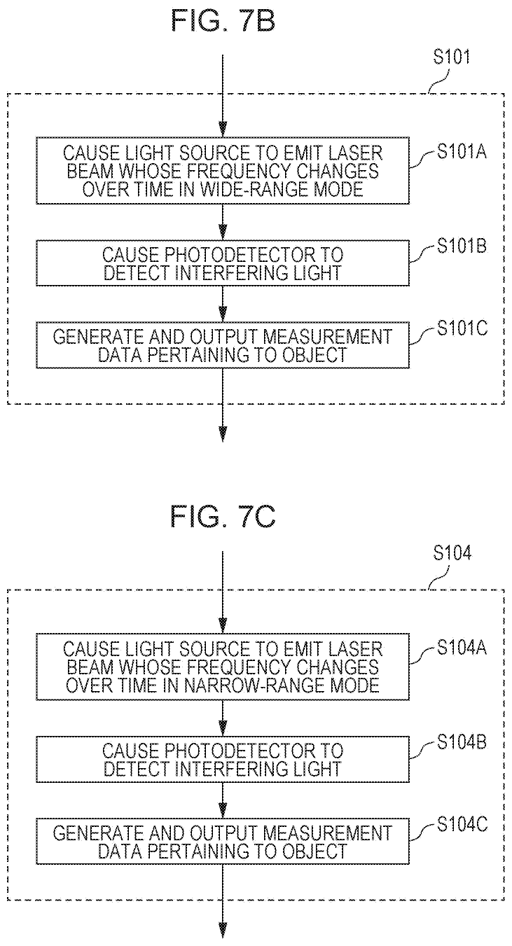

Next, examples of measuring operations that the processing circuit 70 executes are described with reference to FIGS. 7A to 7C. FIG. 7A is a flow chart showing an example of a measuring operation that the processing circuit 70 executes. The processing circuit 70 executes the operation of steps S101 to S105 shown in FIG. 7A. FIGS. 7B and 7C are flow charts showing examples of measuring operations that the processing circuit 70 executes in steps S101 and S104 shown in FIG. 7A, respectively.

### Step S101

The processing circuit 70 makes a measurement of an object 10 a long distance away or a short distance away in the wide-range mode. This operation is detailed as shown in FIG. 7B. The processing circuit 70 causes the light source 20 to emit a laser beam 20L₀ whose frequency changes over time in the wide-range mode (step S101A). The processing circuit 70 causes the photodetector 60 to detect interfering light 20L₄ (step S101B). On the basis of a signal outputted from the photodetector 60, the processing circuit 70 generates and outputs measurement data pertaining to the distance to and the velocity of the object 10 (step S101C).

### Step S102

The processing circuit 70 determines, from the result of measurement obtained in step S101, whether the object 10 is present a short distance away. Instead of the result of the measurement obtained in step S101, a result of a measurement made by another measurement sensor may be used. In a case where the determination is Yes, the processing circuit 70 executes the operation of step S103. In a case where the determination is No, the processing circuit 70 executes the operation of step S101.

### Step S103

The processing circuit 70 determines whether a measurement can be made in the narrow-range mode. If a beat frequency including a Doppler shift is equal to or less than a measurable upper limit, a measurement can be made in the narrow-range mode. In a case where the determination is Yes, the processing circuit 70 executes the operation of step S104. In a case where the determination is No, the processing circuit 70 executes the operation of step S101.

### Step S104

The processing circuit 70 makes a measurement of an object 10 at a short distance in the narrow-range mode. This operation is detailed as shown in FIG. 7C. The processing circuit 70 causes the light source 20 to emit a laser beam 20L₀ whose frequency changes over time in the narrow-range mode (step S104A). The processing circuit 70 causes the photodetector 60 to detect interfering light 20L₄ (step S104B). On the basis of a signal outputted from the photodetector 60, the processing circuit 70 generates and outputs measurement data pertaining to the distance to and the velocity of the object 10 (step S104C). The accuracy of distance measurement in the narrow-range mode in step S104 is higher than the accuracy of distance measurement in the wide-range mode in step S101. Step S105

The processing circuit 70 determines whether to end the measurement. In a case where the determination is Yes, the processing circuit 70 ends the measuring operation. In a case where the determination is No, the processing circuit 70 executes the operation of step S102. Note, however, that in step S102, the processing circuit 70 determines, not from the result of the measurement made in step S101 but from the result of the measurement made in step S104, whether the object 10 is a short distance away.

The measurement apparatus 100 according to the present embodiment can acquire measurement data pertaining to the object 10 by appropriately varying the range and accuracy of distance measurement and the intensity of the irradiating light 20L₂ by switching between operating in the wide-range mode and operating in the narrow-range mode.

Problems with Conventional Configuration in Which Laser Beam 20L₀ Whose Frequency Changes Periodically Is Emitted

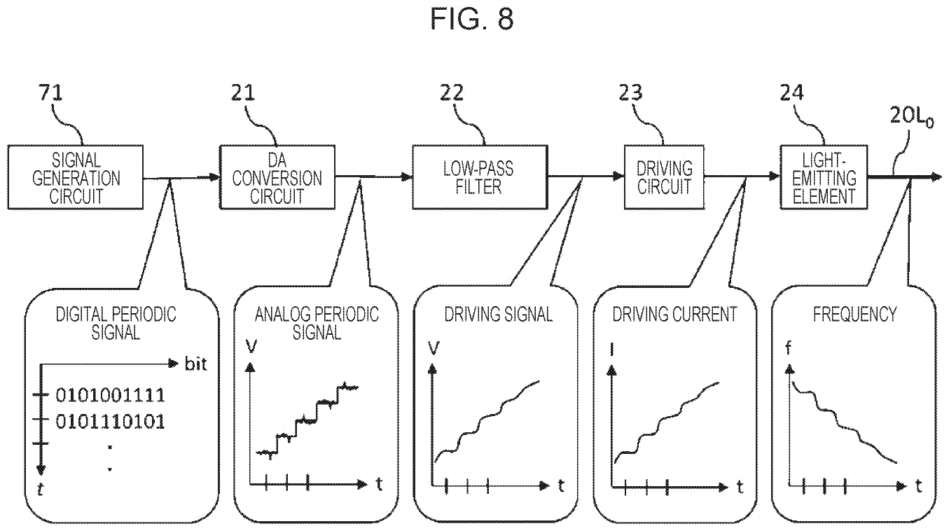

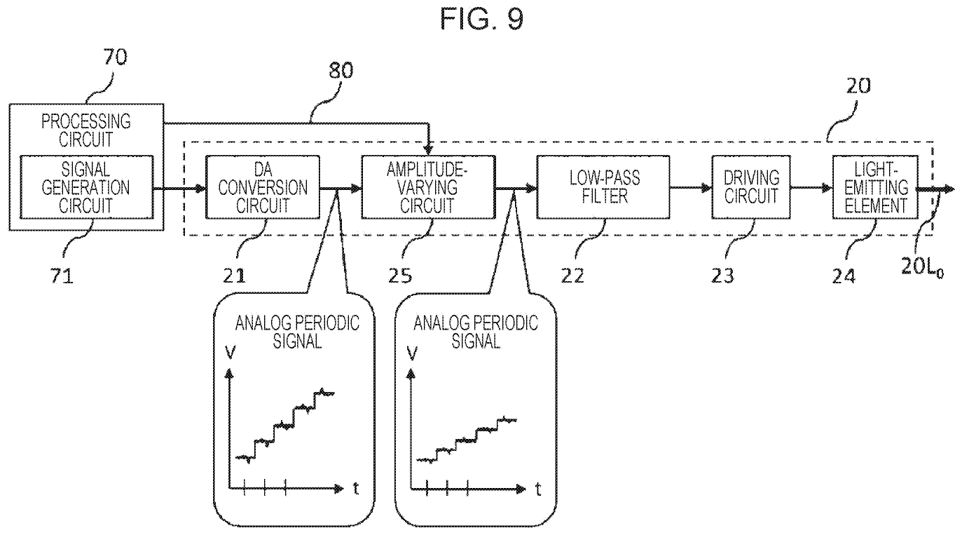

Next, problems with a conventional configuration in which a laser beam 20L₀ whose frequency changes periodically is emitted are described with reference to FIG. 8. Since the laser beam 20L₀ contains irradiating light 20L₂ with which an object 10 is irradiated, the laser beam 20L₀ can also be said to be light with which the object 10 is irradiated. FIG. 8 is a block diagram schematically showing a conventional configuration based on Japanese Unexamined Patent Application Publication No. 2020-008475 in which the laser beam 20L₀ is emitted. The configuration shown in FIG. 8 includes a signal generation circuit 71, a DA conversion circuit 21, a low-pass filter 22, a driving circuit 23, and a light-emitting element 24 in this order.

The signal generation circuit 71 generates a triangular-wave digital periodic signal for periodically changing the frequency of the laser beam 20L₀. The signal generation circuit 71 can be, for example, an FPGA. The DA conversion circuit 21 converts the digital periodic signal into an analog periodic signal and outputs the analog periodic signal. The analog periodic signal is a voltage signal. The low-pass filter 22 generates a driving signal by removing a high-frequency component from the analog periodic signal outputted from the DA conversion circuit 21. The driving circuit 23 changes, on the basis of the driving signal, the frequency of the laser beam 20L₀ emitted from the light-emitting element 24. Specifically, the driving circuit 23 converts the driving signal into a driving current and supplies the driving current to the light-emitting element 24. The light-emitting element 24 emits the laser beam 20L₀ whose frequency changes periodically in the form of a triangular wave. The five word balloons shown in FIG. 8 represent examples of the digital periodic signal, the analog periodic signal, the driving signal, the driving current, and the frequency. These word balloons correspond to behavior in a down-chirp period of the frequency.

As a result of the inventors having studied the conventional configuration, it was found that as the amplitude of the analog periodic signal becomes smaller, the repeatability deteriorates. A reason for this is that as the amplitude of the analog periodic signal becomes smaller, a fluctuation in voltage attributed to noise caused by DA conversion becomes relatively larger with respect to the amplitude. This results in a decrease in the S/N ratio of the driving signal. Examples of the noise include a quantization error, a differential non-linearity error, and an integral non-linearity error. These errors are described as follows:

Quantization error: In DA conversion, a digital signal is composed of a finite number of levels and clocks, so a stepped voltage is generated as an analog signal. A quantization error means a difference between a linear voltage that is an ideal analog signal and a stepped voltage that is an actual analog signal.

Differential non-linearity error: A stepped voltage that is generated by ideal DA conversion is expressed by an integer multiple of an LSB, which is an analog voltage value per level of a digital signal. However, there occurs a slight variation in an actual stepped voltage. A differential non-linearity error means this variation.

Integral non-linearity error: An integral non-linearity error means a difference between an ideal voltage and an actual voltage in an entire signal waveform and corresponds to the cumulative total of differential non-linearity errors.

The inventors found the foregoing problem and conceived of a measurement apparatus 100 according to the present embodiment that addresses the problem. The measurement apparatus 100 according to the present embodiment includes a light source 20 and a processing circuit 70 that are capable of reducing deterioration in the repeatability.

### Specific Configuration of Light Source 20 and Processing Circuit 70

Next, a specific configuration of the light source 20 and the processing circuit 70 that are capable of reducing deterioration in the repeatability is described with reference to FIG. 9. FIG. 9 is a block diagram schematically showing the specific configuration of the light source 20 and the processing circuit 70 in the measurement apparatus 100 according to the present embodiment. The light source 20 shown in FIG. 9 includes a DA conversion circuit 21, an amplitude-varying circuit 25, a low-pass filter 22, a driving circuit 23, and a light-emitting element 24 in this order. The processing circuit 70 shown in FIG. 9 includes a signal generation circuit 71. The measurement apparatus 100 includes a signal line 80 via which the processing circuit 70 and the amplitude-varying circuit 25 are electrically connected to each other. The DA conversion circuit 21, the low-pass filter 22, the driving circuit 23, the light-emitting element 24, and the signal generation circuit 71 are as described with reference to FIG. 8. The driving circuit 23 is further described. That is, a driving current generated by the driving circuit 23 contains a direct-current component and an alternate-current component. The alternate-current component is defined by the driving signal. The direct-current component may be constant regardless of the amplitude of the driving signal or may vary according to the amplitude of the driving signal.

The configuration shown in FIG. 9 differs from the configuration shown in FIG. 8 in that the amplitude-varying circuit 25 is provided between the DA conversion circuit 21 and the driving circuit 23. Although, in the example shown in FIG. 9, the amplitude-varying circuit 25 is provided between the DA conversion circuit 21 and the low-pass filter 22, this example is not intended to impose any limitation. The amplitude-varying circuit 25 may be provided between the low-pass filter 22 and the driving circuit 23.

Except for some exceptions discussed later, the measurement apparatus 100 according to the present embodiment is configured such that regardless of the narrow-range mode or the wide-range mode, the amplitude of the analog periodic signal generated by the DA conversion circuit 21 is fixed so as to come close to the maximum value. Unless otherwise noted, the amplitude of the analog periodic signal generated by the DA conversion circuit 21 is herein simply referred to as “amplitude of the analog periodic signal”. The amplitude of the analog periodic signal can be, for example, 0.8 times or more and 1.0 times or less as great as the maximum value. As the amplitude of the analog periodic signal becomes closer to the maximum value, the aforementioned effect of noise on the repeatability can be better reduced. In a case where the amplitude of the analog periodic signal is at its maximum, the effect of noise is minimized.

In the measurement apparatus 100 according to the present embodiment, the amplitude-varying circuit 25 adjusts the amplitude of the analog periodic signal with a gain. The processing circuit 70 controls the gain through the signal line 80. The two word balloons shown in FIG. 9 represent an unadjusted analog periodic signal to be inputted to the amplitude-varying circuit 25 and an adjusted analog periodic signal outputted from the amplitude-varying circuit 25. Adjusting the amplitude of the analog periodic signal with the gain makes it possible to vary the amplitude of the driving signal according to the narrow-range mode and the wide-range mode, making it possible to adjust the frequency range of the laser beam 20L₀. The gain varies according to the frequency range of the laser beam 20L₀. The gain is greater in the narrow-range mode than it is in the wide-range mode.

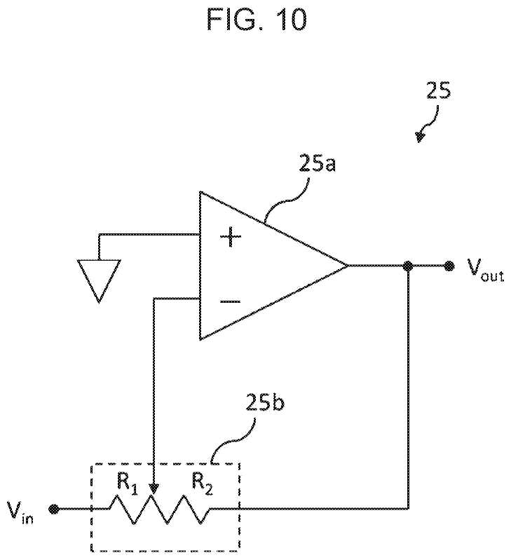

FIG. 10 is a diagram schematically showing an example of the amplitude-varying circuit 25. The amplitude-varying circuit 25 shown in FIG. 10 is a common amplifier circuit that is capable of adjusting a gain. As shown in FIG. 10, the amplitude-varying circuit 25 includes an operational amplifier 25a and a digital potentiometer 25b. The operational amplifier 25a includes a plus terminal serving as a grounded non-inverting input terminal and a minus terminal serving as an inverting input terminal electrically connected to the digital potentiometer 25b.

The digital potentiometer 25b defines the gain in the following manner. The digital potentiometer 25b digitally controls, on the basis of a signal from the processing circuit 70 via the signal line 80, the position of a wiper electrically connected to the minus terminal of the operational amplifier 25a. With reference to the position of the wiper, R₁ is the value of a resistor on the Vᵢₙ side, and R₂ is the value of a resistor on the Vₒᵤₜ side. These resistors are variable resistors. R₁ and R₂ vary depending on the position of the wiper.

The operational amplifier 25a operates so that the voltage difference between the plus terminal and the minus terminal becomes zero. As a result of that, the relationship Vᵢₙ/R₁+Vₒᵤₜ/R₂=0 holds, and Vₒᵤₜ=—(R₂/R₁)Vᵢₙ is obtained. R₂/R₁ corresponds to the gain. The gain may be greater than 1, may be equal to 1, or may be less than 1. The gain herein corresponds to |Vₒᵤₜ|/|Vᵢₙ| and assumes a positive value.

As noted above, the measurement apparatus 100 according to the present embodiment is configured such that by fixing the amplitude of the analog periodic signal so that the amplitude of the analog periodic signal comes close to the maximum value, a fluctuation in voltage attributed to noise caused by DA conversion can be made relatively smaller with respect to the amplitude. This results in improvement in the S/N ratio of the driving signal, which is obtained by combining the amplitude of the analog periodic signal and the gain, making it possible to reduce deterioration in the repeatability.

In a case where, unlike in the measurement apparatus 100 according to the present embodiment, the narrow-range mode and the wide-range mode are achieved by the conventional configuration shown in FIG. 8, the amplitude of the analog periodic signal is adjusted via the digital periodic signal through the signal generation circuit 71. Specifically, by increasing the amplitude of the analog periodic signal, the frequency range becomes wider, with the result that the narrow-range mode is achieved. Further, by decreasing the amplitude of the analog periodic signal, the frequency range becomes narrower, with the result that the wide-range mode is achieved. Note, however, that as mentioned above, in a case where the amplitude of the analog periodic signal is small, the S/N ratio of the driving signal decreases, so that there is deterioration in the repeatability.

The phrase “varying the amplitude of the analog periodic signal via the digital periodic signal through the signal generation circuit 71” herein means that as a result of the signal generation circuit 71 having changed the digital periodic signal, the amplitude of the analog periodic signal generated by the DA conversion circuit 21 is varied.

### Relationship Between Amplitude and S/N Ratio of Driving Signal

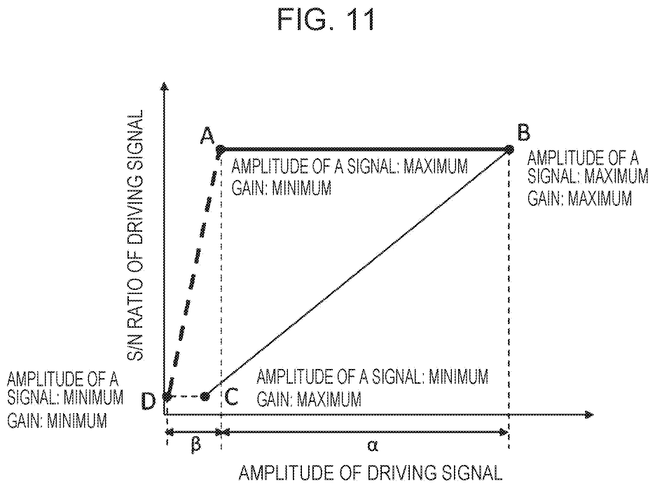

Next, a relationship between the amplitude and S/N ratio of the driving signal in the measurement apparatus 100 according to the present embodiment is described with reference to FIG. 11. FIG. 11 is a graph schematically showing a relationship between the amplitude and S/N ratio of the driving signal in the present embodiment.

The point A shown in FIG. 11 represents a state where the amplitude of the analog periodic signal is at its maximum and the gain is at its minimum. The point B shown in FIG. 11 represents a state where the amplitude of the analog periodic signal is at its maximum and the gain is at its maximum. The point C shown in FIG. 11 represents a state where the amplitude of the analog periodic signal is at its minimum and the gain is at its maximum. The point D shown in FIG. 11 represents a state where the amplitude of the analog periodic signal is at its minimum and the gain is at its minimum. The “A SIGNAL” shown in FIG. 11 represents the analog periodic signal. The quadrangular ABCD shown in FIG. 11 represents the ranges of the amplitude and S/N ratio of a driving signal that can be achieved by adjusting the amplitude of the analog periodic signal and the gain.

In the measurement apparatus 100 according to the present embodiment, the amplitude of a desired driving signal is achieved by varying the gain through the amplitude-varying circuit 25 in a state where the amplitude of the analog periodic signal is fixed at its maximum on the segment AB represented by a thick solid line. In other words, in a case where the frequency range is changed from a first frequency range to a second frequency range, the amplitude of the analog periodic signal in a case of the first frequency range and the amplitude of the analog periodic signal in a case of the second frequency range are identical to each other, and the gain in the case of the first frequency range and the gain in the case of the second frequency range are different from each other. Unlike in the measurement apparatus 100 according to the present embodiment, it is also conceivable that the amplitude of the desired driving signal may be achieved by varying the amplitude of the analog periodic signal via the digital periodic signal through the signal generation circuit 71 in a state where the gain is fixed at its maximum on the segment BC represented by a thin solid line.

Comparing the two cases shows that as shown in FIG. 11, the S/N ratio of the driving signal in a case where the amplitude of the driving signal is adjusted on the segment AB is higher than or equal to the S/N ratio of the driving signal in a case where the amplitude of the driving signal is adjusted on the segment BC. In the former case, the S/N ratio of the driving signal can be kept at a high value even when the amplitude of the driving signal is small. A reason for this is that the S/N ratio of the driving signal depends on the amplitude of the analog periodic signal and does not depend on the gain. In the range α shown in FIG. 11, it is on the segment AB that the S/N ratio of the driving signal reaches a maximum level. The range α is a range within which the amplitude of the driving signal is greater than or equal to a value obtained by multiplying the maximum value of the analog periodic signal by the minimum value of the gain and less than or equal to a value obtained by multiplying the maximum value of the analog periodic signal by the maximum value of the gain.

Note, however, that in a case where the amplitude of the desired driving signal is excessively small, the amplitude of the desired driving signal may not be achieved on the segment AB. In that case, in the measurement apparatus 100 according to the present embodiment, the amplitude of the desired driving signal is achieved by varying the amplitude of the analog periodic signal via the digital periodic signal through the signal generation circuit 71 in a state where the gain is fixed at its minimum on the segment AD represented by a thick dashed line. In other words, in a case where the frequency range is changed from a first frequency range to a second frequency range and in a case where the second frequency range is narrower than a frequency range obtained when the gain is set to a minimum value, the signal generation circuit 71 changes the digital periodic signal. Unlike in the measurement apparatus 100 according to the present embodiment, it is also conceivable that the amplitude of the desired driving signal may be achieved by varying the gain through the amplitude-varying circuit 25 in a state where the amplitude of the analog periodic signal is fixed at its minimum on the segment CD represented by a thin dashed line.

Comparing the two cases shows that as shown in FIG. 11, the S/N ratio of the driving signal in a case where the amplitude of the driving signal is adjusted on the segment AD is higher than or equal to the S/N ratio of the driving signal in a case where the amplitude of the driving signal is adjusted on the segment CD. In the former case, the S/N ratio of the driving signal becomes higher with distance from the point D. In the range R shown in FIG. 11, it is on the segment AD that the S/N ratio of the driving signal reaches a maximum level. The range R is a range within which the amplitude of the driving signal is greater than or equal to a value obtained by multiplying the minimum value of the analog periodic signal by the minimum value of the gain and less than or equal to a value obtained by multiplying the maximum value of the analog periodic signal by the minimum value of the gain.

For all these reasons, the measurement apparatus 100 according to the present embodiment adjusts the amplitude of the driving signal on the segments AB and AD in order to achieve the narrow-range mode and the wide-range mode. This results in improvement in the S/N ratio of the driving signal as compared with a case where the amplitude of the driving signal is adjusted on the segments BC and CD, making it possible to reduce deterioration in the repeatability.

If both the narrow-range mode and the wide-range mode can be achieved by adjusting the amplitude of the driving signal on the segment AB, both modes can be achieved in a state where the S/N ratio of the driving signal is kept at a high value. While the narrow-range mode can be achieved by adjusting the amplitude of the driving signal on the segment AB, there is a case where the wide-range mode cannot be achieved by adjusting the amplitude of the driving signal on the segment AB. Even in that case, the wide-range mode can be achieved by adjusting the amplitude of the driving signal on the segment AD, so that the wide-range mode can be achieved in a state where the S/N ratio of the driving signal is comparatively high.

In a case where both modes are achieved by adjusting the amplitude of the driving signal on the segment AB, the gain varies between the two modes. Even in a case where the narrow-range mode is achieved by adjusting the amplitude of the driving signal on the segment AB and the wide-range mode is achieved by adjusting the amplitude of the driving signal on the segment AD, the gain varies between the two modes unless the narrow-range mode coincides with the point A. In either case, the gain can be said to vary according to the frequency range of each mode, as the frequency range varies between the two modes.

It should be noted that at the points A and B, the amplitude of the analog periodic signal does not need to be at its maximum and, for example, may be 0.8 times or more and 1.0 times or less as great as the maximum value. At the points C and D, the amplitude of the analog periodic signal does not need to be at its minimum and, for example, may be 1.0 time or more and 1.2 times or less as great as the minimum value. At the points B and C, the gain does not need to be at its maximum and, for example, may be 0.8 times or more and 1.0 times or less as great as the maximum value. At the points A and D, the gain does not need to be at its minimum and, for example, may be 1.0 times or more and 1.2 times or less as great as the minimum value.

### Operation of Driving Light Source 20

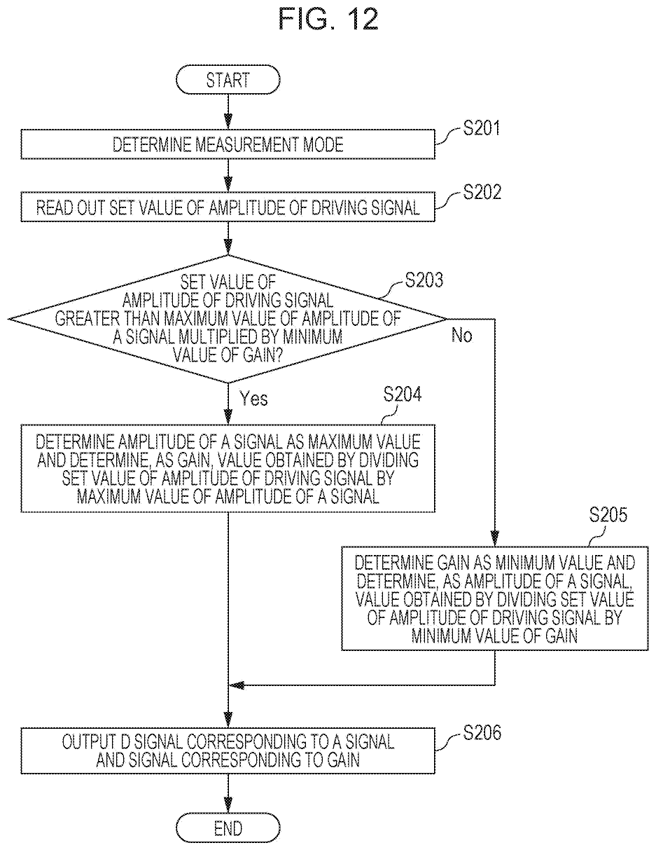

Next, an example of an operation that the processing circuit 70 executes in step S101A shown in FIG. 7B and step S104A shown in FIG. 7C to drive the light source 20 is described with reference to FIG. 12. FIG. 12 is a flow chart showing an example of an operation that the processing circuit 70 executes to drive the light source 20. The processing circuit 70 executes the operation of steps S201 to S206 shown in FIG. 12.

### Step S201

The processing circuit 70 determines a measurement mode. The measurement mode is either the narrow-range mode or the wide-range mode.

### Step S202

The processing circuit 70 reads out a set value of the amplitude of a driving signal according to the measurement mode from the memory 72. Prior to a measuring operation, the memory 72 has stored therein set values of the amplitude of the driving signal in the narrow-range mode and the wide-range mode.

### Step S203

The processing circuit 70 determines whether the set value of the amplitude of the driving signal is greater than a value obtained by multiplying the maximum value of the amplitude of the analog periodic signal by the minimum value of the gain. The value corresponds to a horizontal axis value at the point A shown in FIG. 11. In a case where the determination is Yes, the processing circuit 70 executes the operation of step S204. In a case where the determination is No, the processing circuit 70 executes the operation of step S205.

### Step S204

The processing circuit 70 determines the amplitude of the analog periodic signal as the maximum value and determines, as the gain, a value obtained by dividing the set value of the amplitude of the driving signal by the maximum value of the amplitude of the analog periodic signal. By the gain thus determined and the amplitude of the analog periodic signal, the amplitude of the driving signal on the segment AB shown in FIG. 11 can be achieved.

### Step S205

The processing circuit 70 determines the gain as the minimum value and determines, as the amplitude of the analog periodic signal, a value obtained by dividing the set value of the amplitude of the driving signal by the minimum value of the gain. By the gain thus determined and the amplitude of the analog periodic signal, the amplitude of the driving signal on the segment AD shown in FIG. 11 can be achieved.

### Step S206

As shown in FIG. 9, the processing circuit 70 or, more specifically, the signal generation circuit 71 included in the processing circuit 70 outputs, toward the DA conversion circuit 21, a digital periodic signal corresponding to the analog periodic signal whose amplitude has been determined as noted above. The “D signal” shown in FIG. 12 represents the digital periodic signal. Furthermore, as shown in FIG. 9, the processing circuit 70 outputs, via the signal line 80 toward the amplitude-varying circuit 25, a signal corresponding to the gain determined as noted above.

The foregoing driving operation allows the light source 20 to be driven by a driving signal having a high S/N ratio. Accordingly, in comparison with a measurement apparatus including the conventional configuration shown in FIG. 8, the measurement apparatus 100 according to the present embodiment can reduce deterioration in the repeatability, making it possible to more accurately acquire measurement data pertaining to an object 10.

The foregoing driving operation may be partially altered in the following manner. Prior to the measuring operation, the following table created on the basis of the process in steps S203 to S205 is stored in the memory 72. The table contains a correspondence relationship among the amplitudes of a plurality of driving signals, the amplitudes of a plurality of analog periodic signals, and a plurality of gains. Each of the amplitudes of the plurality of driving signals corresponds to one of the amplitudes of the plurality of analog periodic signals and one of the plurality of gains. Instead of executing steps S203 to S205 in the driving operation shown in FIG. 12, the processing circuit 70 may read out the table from the memory 72 and determine, on the basis of the table, the amplitude of an analog periodic signal and a gain that correspond to the set value of the amplitude of the driving signal.

### EXAMPLES

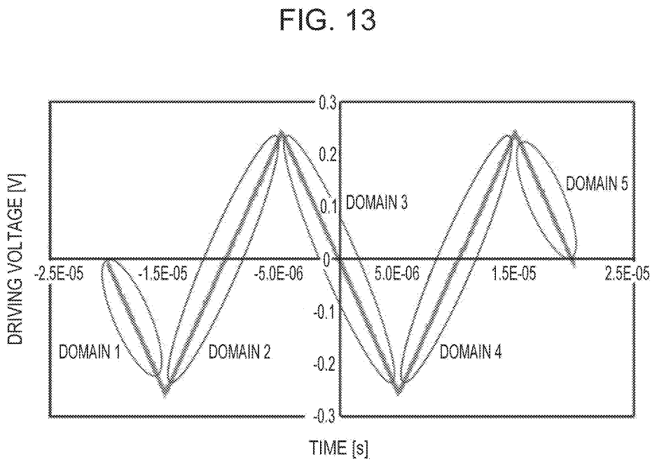

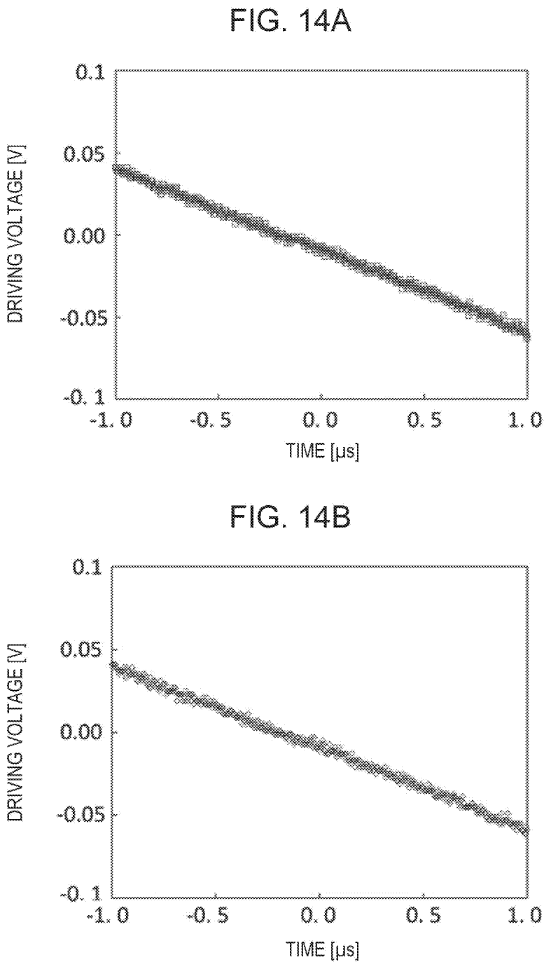

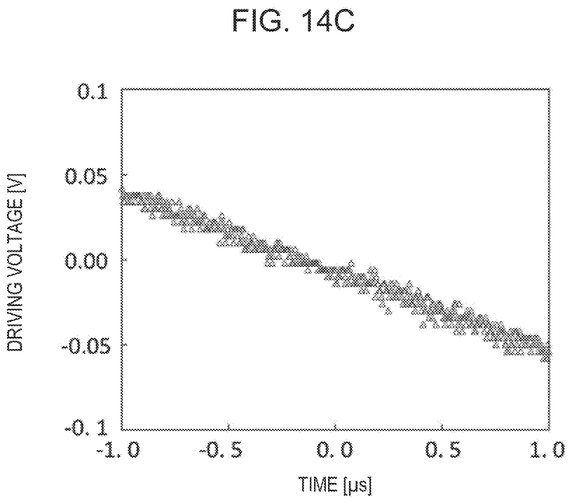

Next, an example of an operation of driving the light source 20 included in the measurement apparatus 100 according to the present embodiment is described with reference to FIGS. 13 to 14C and Table 1. FIG. 13 is a graph showing a relationship between time and voltage of the driving signal in the light source 20 in the example. The horizontal axis represents time, and the vertical axis represents the voltage of the driving signal, i.e. driving voltage. In the example shown in FIG. 13, the amplitude of the driving voltage is approximately ±250 mV. The driving voltage is attained by combining the amplitude of the analog periodic signal and the gain under the following conditions. The following conditions are the condition that the bit number of the digital periodic signal is 14, the condition that the maximum value of the amplitude of the analog periodic signal is ±1.0 V, and the condition that the adjustable range of the gain is from 0.5 to 1.0.

Table 1 shows repeatability in three examples of combinations of the amplitude of an analog periodic signal and a gain. In the first example, the amplitude of the analog periodic signal is ±500 mV, and the gain is 0.5. In the second example, the amplitude of the analog periodic signal is ±330 mV, and the gain is 0.75. In the third example, the amplitude of the analog periodic signal is ±250 mV, and the gain is 1.0.

The repeatability was evaluated by making fifty measurements of the distance to and the velocity of an object 10 that was at rest 1 m away from the measurement apparatus 100. The “Error in Driving Voltage” shown in Table 1 represents an integral non-linearity error obtained by separately evaluating up-chirp and down-chirp periods of two cycles of triangular-wave driving voltage shown in FIG. 13. The up-chirp periods of the driving voltage correspond to “DOMAIN 2” and “DOMAIN 4” shown in FIG. 13, and the down-chirp periods of the driving voltage correspond to “DOMAIN 1”, “DOMAIN 3”, and “DOMAIN 5” shown in FIG. 13.

TABLE 1

| Gain | 0.5 | | 0.75 | | 1.0 | |
|---|---|---|---|---|---|---|
| Amplitude of Analog | ±500 mV | | ±330 mV | | ±250 mV | |
| Periodic Signal | (12289 to 4093) | | (10896 to 5486) | | (10240 to 6142) | |
| (Digital Value) | | | | | | |
| Amplitude of Actual | 245 mV to −255 mV | | 241 mV to −253 mV | | 246 mV to −262 mV | |
| Driving Voltage | | | | | | |
| Error in Driving | 1.67 | mV | 1.72 | mV | 3.90 | mV |
| Voltage | | | | | | |
| Standard Deviation | 0.63 | mm | 0.86 | mm | 1.18 | mm |
| of Distance | | | | | | |
| Standard Deviation | 0.014 | km/h | 0.018 | km/h | 0.028 | km/h |

of Velocity

As shown in Table 1, while the first to third examples are substantially the same in “Amplitude of Actual Driving Voltage”, the first example is the smallest in “Error in Driving Voltage”, “Standard Deviation of Distance”, and “Standard Deviation of Velocity”, the second example is the second smallest, and the third example is the largest.

FIGS. 14A to 14C are graphs showing, in closeup, parts of relationships between driving voltage and time in the first to third examples, respectively. As shown in FIGS. 14A and 14B, in the case of a gain of 0.5 and the case of a gain of 0.75, the variances in driving voltage are substantially the same. As shown in FIG. 14C, the variance in driving voltage in the case of a gain of 1.0 is greater than the variances in driving voltage in the case of a gain of 0.5 and the case of a gain of 0.75. The variances in driving voltage shown in FIGS. 14A to 14C correspond to the “Error in Driving Voltage” shown in Table 1.

The examples show that the larger the amplitude of an analog periodic signal is, the more effectively deterioration in the repeatability can be suppressed, and measurement data pertaining to the object 10 can be acquired more accurately.

### CONCLUSION

The foregoing description of embodiments discloses the following technologies.

### Technology 1

A measurement apparatus including:
a light-emitting element that emits light for irradiating an object, wherein a frequency of the light changes periodically, and a frequency range over which the frequency changes is adjustable;
a signal generation circuit that generates a digital periodic signal;
a digital-to-analog conversion circuit that converts the digital periodic signal into an analog periodic signal and outputs the analog periodic signal;
an amplitude-varying circuit that generates a driving signal by adjusting an amplitude of the analog periodic signal using a gain;
a driving circuit that varies the frequency in accordance with the driving signal; and a signal line electrically connected to the amplitude-varying circuit and used to control the gain.

This measurement apparatus makes it possible to more accurately acquire measurement data pertaining to the object.

### Technology 2

The measurement apparatus according to technology 1, wherein the gain is different depending on the frequency range.

This measurement apparatus makes it possible to change the frequency range of light by adjusting the gain.

### Technology 3

The measurement apparatus according to technology 1 or 2, wherein the amplitude-varying circuit includes a digital potentiometer that defines the gain.

This measurement apparatus makes it possible to adjust the gain through the use of a variable resistor.

### Technology 4

The measurement apparatus according to any of technologies 1 to 3, wherein in a case where the frequency range is changed, the amplitude-varying circuit varies the gain in a state where the amplitude of the analog periodic signal outputted from the digital-to-analog conversion circuit is fixed.

This measurement apparatus makes it possible to change the frequency range of light in a state where the S/N ratio of a driving signal is kept at a high value, as the amplitude of the analog periodic signal is fixed.

### Technology 5

The measurement apparatus according to any of technologies 1 to 3, wherein in a case where the frequency range is changed, and in a state where the amplitude of the analog periodic signal outputted from the digital-to-analog conversion circuit is fixed, when a desired frequency range is not able to be achieved even if the amplitude-varying circuit varies the gain, the signal generation circuit changes the digital periodic signal.

This measurement apparatus makes it possible to achieve a desired narrow frequency range in a state where the S/N ratio of a driving signal is comparatively high.

### Technology 6

The measurement apparatus according to any of technologies 1 to 3, wherein in a case where the frequency range is changed from a first frequency range to a second frequency range, the amplitude of the analog periodic signal in a case of the first frequency range and the amplitude of the analog periodic signal in a case of the second frequency range are identical to each other, and the gain in the case of the first frequency range and the gain in the case of the second frequency range are different from each other.

This measurement apparatus makes it possible to change the frequency range of light in a state where the S/N ratio of a driving signal is kept at a high value, as the amplitude of the analog periodic signal is fixed.

### Technology 7

The measurement apparatus according to any of technologies 1 to 3, wherein in a case where the frequency range is changed from a first frequency range to a second frequency range, when the second frequency range is narrower than a frequency range obtained when the gain is set to a minimum value, the signal generation circuit changes the digital periodic signal.

This measurement apparatus makes it possible to achieve a desired narrow frequency range in a state where the S/N ratio of a driving signal is comparatively high.

A measurement apparatus according to an embodiment of the present disclosure can be utilized for uses, for example, in a distance-measuring system that is mounted in a vehicle such as an automobile, an unmanned aerial vehicle (UAV), or an automated guided vehicle (AGV) or in vehicle detection.

What is claimed is:

1. A measurement apparatus comprising:
a light emitter that emits light for irradiating an object, wherein a frequency of the light changes periodically, and a frequency range over which the frequency changes is adjustable;
a signal generator that generates a digital periodic signal;
a digital-to-analog converter that converts the digital periodic signal into an analog periodic signal and outputs the analog periodic signal;
an amplitude adjuster that generates a driving signal by adjusting an amplitude of the analog periodic signal using a gain;
a driver that varies the frequency in accordance with the driving signal; and
a signal line electrically connected to the amplitude adjuster and used to control the gain.

2. The measurement apparatus according to claim 1, wherein the gain is different depending on the frequency range.

3. The measurement apparatus according to claim 1, wherein the amplitude adjuster includes a digital potentiometer that defines the gain.

4. The measurement apparatus according to claim 1, wherein in a case where the frequency range is changed, the amplitude adjuster varies the gain in a state where the amplitude of the analog periodic signal outputted from the digital-to-analog converter is fixed.

5. The measurement apparatus according to claim 1, wherein in a case where the frequency range is changed, and in a state where the amplitude of the analog periodic signal outputted from the digital-to-analog converter is fixed, when a desired frequency range is not able to be achieved even if the amplitude adjuster varies the gain, the signal generator changes the digital periodic signal.

6. The measurement apparatus according to claim 1, wherein in a case where the frequency range is changed from a first frequency range to a second frequency range, the amplitude of the analog periodic signal in a case of the first frequency range and the amplitude of the analog periodic signal in a case of the second frequency range are identical to each other, and the gain in the case of the first frequency range and the gain in the case of the second frequency range are different from each other.

7. The measurement apparatus according to claim 1, wherein in a case where the frequency range is changed from a first frequency range to a second frequency range, when the second frequency range is narrower than a frequency range obtained when the gain is set to a minimum value, the signal generator changes the digital periodic signal.
